(19) United States
(12) Patent Application Publication
(10) Pub. No.: US 2009/0043767 A1
(43) Pub. Date: Feb. 12, 2009

(54) Approach For Application-Specific Duplicate Detection

(76) Inventors: Ashutosh Joshi, Laxminagar (IN); Vinoth Jayaraman, Salem (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/835,365

(22) Filed: Aug. 7, 2007

(51) Int. Cl. G06F 17/30

(52) U.S. Cl. 707/6; 707/E17.001

(57) ABSTRACT

Techniques are provided for extracting view data from documents, where the data corresponds to an application-specific view and includes a plurality of components. Component data is identified within the view data and a view signature is generated for the view data that includes component signatures generated for each of the components on which the view data is comprised. Each component signature is generated based on the component data that corresponds to each component. The signatures generated are used to detect duplicates among the documents.

### FIELD OF THE INVENTION

The present invention relates to information extraction from documents and, more specifically, to identifying duplicate information from the documents.

### BACKGROUND

As the amount of content, such as documents, images, videos and sound files, proliferates on the Internet, users have begun to rely more heavily on Internet search engines to locate and view content in which they are interested. One example of a search engine is a computer program designed to find documents stored in a computer system, such as the World Wide Web. The search engine's tasks typically include finding documents, analyzing documents, and building an index that supports efficient document retrieval.

A user describes the documents she is seeking with a query. In a common case, a query is a set of words, which should appear in the documents. Web sites such as Yahoo™ offer the capability to search for links to content on the Internet that is deemed relevant to a search query, such as web pages and multimedia, among other categories. In response to a query, the web site performing the search query may display content extracted from other web sites in addition to links to content.

Certain applications have been developed to organize information on the Internet that pertains to a specific need, such as shopping and travel. For example, a shopping application may only be interested in information about a particular product such as price and an item identifier, and not other content on the same web page as such as images and descriptive text.

Replicated content is a common problem faced by these applications. Replicated content causes additional processing for the application, takes up increased storage space, and may result in a bad user experience if the user is presented with the replicated content in response to a search query. Therefore, a common need with regard to identifying and organizing data related to an application is to identify and exclude replicated content so that it does not cause the problems described above.

A current approach to identifying replicated content is to examine an entire document, such as a web page, and compare the source code of the document to the source code of other documents in order to determine if the document is a duplicate. For example, the HTML code defining a web page is examined and compared to the HTML code of other web pages that have already been stored. If the HTML matches, then the document is considered a duplicate. A drawback to this approach is that a particular application may only be interested in a small portion of the document being analyzed, so if a portion of the document that the application is not interested in is the only difference between the analyzed document and the stored documents, the web page is considered a non-duplicate, which does not take the application's needs into account.

Another approach to identifying replicated content is to break the document into portions, compute a fingerprint for each portion, and compare the fingerprints to fingerprints generated from previously-examined documents in order to determine whether the document is a duplicate. A drawback to this approach is that it considers the entire document rather than only the portion pertaining to a specific application.

Therefore, an approach for detecting application-specific duplicate content, which does not experience the disadvantages of the above approaches, is desirable. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is a block diagram of an example of duplicate detection according to an embodiment;

FIG. 1B is a block diagram of an example of duplicate detection according to an embodiment;

FIG. 2 is a block diagram illustrating an example of creating signatures for a document view, according to an embodiment;

FIG. 3 is a block diagram illustrating an signature store and index according to an embodiment;

FIG. 4 is a flow diagram illustrating a procedure for application-specific duplicate detection, according to an embodiment;

FIG. 5 is a block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Functional Overview

Techniques are provided for identifying duplicate documents based on extracting data made up of a portion of a document based on an application-specific view, and comparing the data extracted from other documents. An application-specific view comprises components, parts of documents, and/or items of information within the documents that are relevant for treating documents as being duplicates for a particular application, purpose, or domain. An application-specific view may be referred to herein as simply a view.

According to an embodiment, an approach is provided for extracting view data from a document (e.g. web page), where the view data corresponds to an application-specific view. View data from and/or derived from a document is referred to herein as a document view.

An application specific view includes a plurality of components, referred to herein as view components. View component data for a view component is identified within the view data. View component data from a document is referred to herein as a document view component. For each document view component of an application-specific view for a document, one or more component signatures are generated based on the document view component. The set of component signatures generated for a view of a document is referred to as a view signature. The view signatures of different documents are compared to establish which are duplicates or partial duplicates of each other based on a view.

### Application-Specific Duplicate Detection

A set of documents, such as web pages, may look different and have different content; however, from the perspective of an application that is only concerned with a portion of the information in the documents, the documents may be treated as being identical. For example, consider two websites selling products from a common product store, such as two affiliates of the common product store. On these two sites, the pages selling the same product may look different, the HTML defining the pages may be totally different, and on a whole the pages may not be identical if the entire content is considered; however, for an application only interested in information related to the product, such as name and price, the two pages are identical. Previous approaches would determine that the pages are not identical and therefore incur the difficulties described above with regard to mistaken duplicate detection.

Another example is a “travel” application only interested in certain information about lodging that is available on the Internet, application-specific information such as the name, address, and phone number of an individual lodging entity. The same individual lodging entity may be described on numerous documents (such as web pages at different web sites), each document having different characteristics except for the name, address, and phone number of a particular lodging entity, which is the same on each site. Conventional duplicate detection treats each document as unique, even though the information that is application-specific is the same, leading to needless consumption of processing and storage resources. From the perspective of the travel application, the only part of the documents that are relevant for duplicate detection is the application-specific information, i.e., name, the address, and phone number of each particular lodging entity. In an embodiment of the invention, only the name, address, and phone number of each individual lodging entity are extracted from a document. Signatures for these items of information are generated and compared to signatures generated for names, addresses, and phone numbers that were previously-extracted from other documents. Based on the comparison, a determination is made of whether the application-specific information is identical. If so, then the particular document does not need to be processed and stored. If the information is not present, then application-specific information from the particular document is processed and stored for future use.

### Creating Application-Specific Views

An application-specific view may be comprised of particular portions of a document in which an application is interested. For example, a book shopping application may be interested in a subset of a document, only interested in the portions of documents containing ISBN numbers and the prices associated with the ISBN numbers. The application-specific view for documents to be analyzed by the application is therefore comprised of ISBN numbers and prices. In an embodiment, a view may be considered a template that defines what information is relevant to an application in a document. In an embodiment, a view may be stored in a standard format such as ASCII or XML.

A document view of a document is created by examining a document and extracting the application-specific data pertaining to the view. For example, a document view comprising ISBN numbers and prices is created by examining a web page and extracting all the ISBN numbers and prices from the web page, using for example pattern-matching techniques.

According to an embodiment, transformations may be applied to the data in the document in order to obtain a final document view. For example, the various components in the view (such as the ISBN and price) may be sorted to obtain a deterministic ordering. Also, a juxtaposition of the components may be performed in order to obtain a contiguous stream. Also, the components may be normalized; for example, removing non-alphabetic or numeric characters, converting the case of the text, standardizing numeric fields, stop-word removal, and stemming.

An example of identifying duplicate documents based on view construction is an application which extracts product information from product web pages of an online shopping site. The information extracted by the application could include, but not be restricted to, the title, price, image and description. This data extraction involves significant processing such as identifying the correct title from all the distinct text on the page, identifying the correct image from a number of images on the page, and so forth. It is desirable to avoid performing this processing for products that the application has already obtained from another source, such as another web site.

In an example, an application may consider two products to be duplicates if they have the same description and price. However, duplicate detection may not be restricted to these particular attributes. For each document, an approach may be to examine the text portions that are comprised of a threshold number of characters, and the prices in the documents, and then check them for duplicates. In this example, a document view of a document is a collection of all the text portions and prices in the document. In this example, even if two affiliate sites have web pages showing the same product but have different layouts, thereby being non-duplicate documents, they will be identified as duplicates in the view space.

In another example, if two documents have almost identical content, they may be identified as duplicates by current approaches to duplicate detection. However, if the documents vary slightly in the content specific to the particular application needs, then the documents should not be identified as duplicates. For example, if two affiliate sites sell the same product but at different prices, and the site pages differ minimally, the pages may be incorrectly considered as duplicates when the view-specific detection indicates that the documents are not duplicates.

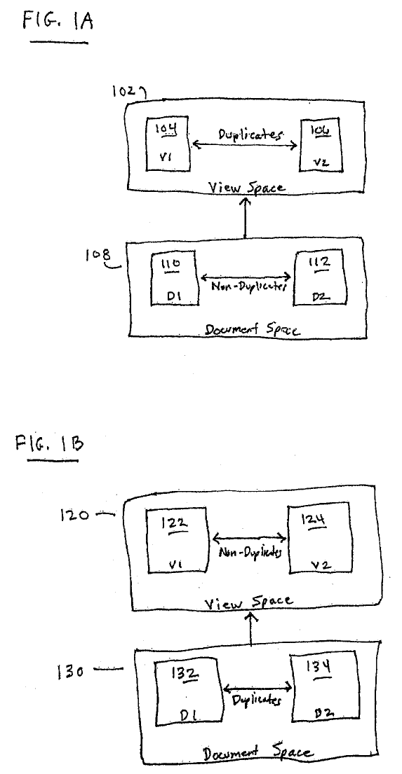

FIG. 1A is a block diagram of an example of duplicate detection according to an embodiment. In FIG. 1A, two documents 110, 112 labeled D1 and D2 exist in a document space 108. These documents are non-duplicates; for example, document D1 110 may be a web page describing a particular hotel at travelcity.com, and document D2 112 may be the web page of the same hotel at travelmaster.com. The web pages look different and contain different text, except for certain text describing the hotel. A travel application-specific view in this example comprises hotel names and phone numbers. When the documents are translated into document view V1 104 and V2 106, then the document views are deemed duplicates even though documents 110, 112 on which the document views are based are not considered duplicates. This result is due to the hotel names and phone numbers from which the document views 104, 106 are constructed being identical. In an embodiment, even though a document view component of a view may not be identical, the documents may still be designated as duplicates based on a weighted calculation of a numerical score, as described further herein.

FIG. 1B is a block diagram of an example of duplicate detection according to an embodiment. In FIG. 1B, two documents 132, 134 labeled D1 and D2 exist in document space 130. These documents are non-duplicates but have similar content; for example, page D1 132 may be a web page of a particular book for sale at bookstore.com, and page D2 134 may be the web page of the same book for sale at bookmall.com. The web pages are selling the same item, perhaps as affiliates of the same web site, and are similar enough that under some duplicate detection mechanisms pages are deemed duplicates. An application-specific view in this example comprises book ISBN numbers and prices. When the documents are translated into view space 120, then the particular document views V1 122 and V2 124 are considered non-duplicates even though the documents 132, 134 on which the views are based are considered duplicates. Specifically, this may be because the prices of the books, which is a component of which the document views 122, 124 are constructed, are not identical. In an embodiment, even though a document view component of the views may be identical, such as the ISBN number in this example, the documents may still be designated as non-duplicates based on a weighted calculation of a numerical score, as described further herein.

### Generating and Storing View Signatures

After a document view has been generated for a document, signatures may be created for the document view. An example of a signature is a hash key created by transforming a document view through a hash function. An advantage of creating a signature of a document view is that the signature has a unique value for a specific data value and a signature can take up much less space than the document view. For example, a document view may comprise 500 characters, but after being transformed via a hash function, the resulting hash key signature may only take up sixteen characters and provide the same ability to match one document view with another document view.

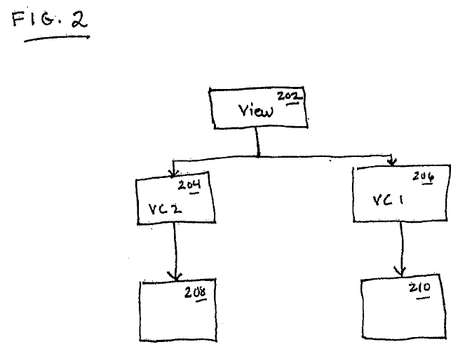

FIG. 2 is a block diagram illustrating an example of creating signatures for a document view. In FIG. 2, a document view 202 of a document is constructed. The document view is then split into separate document view components VC1 and VC2 204, 206. While the example illustrated in FIG. 2 has two document view components 204, 206, any number may be created. One approach to splitting the document view 202 into document view components 204, 206 is to consider each field in the document view 202 as a separate entity. For example, in the case of a product web page, the two document view components 204, 206 may be “text blurbs” and “prices.” In an embodiment, the application may group some fields together into a single component. For example, a field in the view comprising an item title and a field in the view comprising an item description could be grouped into a single view component.

For each document view component 204, 206, a signature set 208, 210 for the view component may be calculated using standard techniques such as hashing or shingling. An example of determining document view components of an application-specific view and computing signatures based on the document view components is as follows. An online store sells books, and the particular application is only interested in ISBN numbers and prices, so those data items comprise the document view for each of the documents (web pages). All pages of the online book store are retrieved and stored. The application, or another entity, extracts the data corresponding to the view from the stored pages; i.e., the ISBN numbers and prices. The document view is all the information extracted by the processing. The document view is divided into two view components: ISBN numbers and prices. For each ISBN number that populates the first document view component, a signature is created. For each price that populates the second document view component, a signature is created. If 8 ISBN numbers and eight prices were extracted from the documents, each document view component would have eight entries and each signature set would have eight entries. In an embodiment, the entire data set constructed for each document view component and/or the entire signature set may be concatenated together. Alternatively, rather than generating a signature for each item of a document view component, signatures from various combination of items are generated. For example, a moving window of size 2 may be used to generate signatures for the 8 ISBN numbers. A first signature is generated by concatenating the first and second ISBN numbers. A second signature is generated by concatenating the second and third ISBN number, and so forth. What ever approach is used to generate signatures, it should be the same for all the documents being compared.

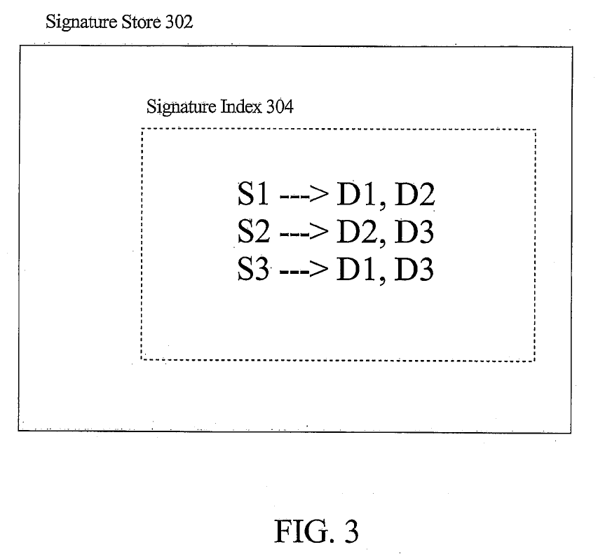

The signatures generated from documents may be stored in a signature store to be used for comparison with signatures generated for other documents. FIG. 3 depicts a signature store according to an embodiment of the present invention.

Referring to FIG. 3, it depicts signature store 302, which is generated for document view 202 of a set of documents. Signature store 302 includes signature index 304, which indexes signatures generated for VC1. Signature store 302 may contain other signature indexes for other view components.

The index key values of signature index 304 are the component signatures generated for VC1 from the set of documents. Each entry of signature index 304 maps a key signature value to a list of documents from which the signature is generated. The first entry maps signature S1 to documents D1 and D2, S2 to documents D2 and D3, and S3 to documents D1 and D3. Signature index 304 thus implies S1 comes from D1 and D2, S2 from D2 and D3, and S3 from D1 and D3.

### Detecting Duplicate Documents Using View-Based Signatures

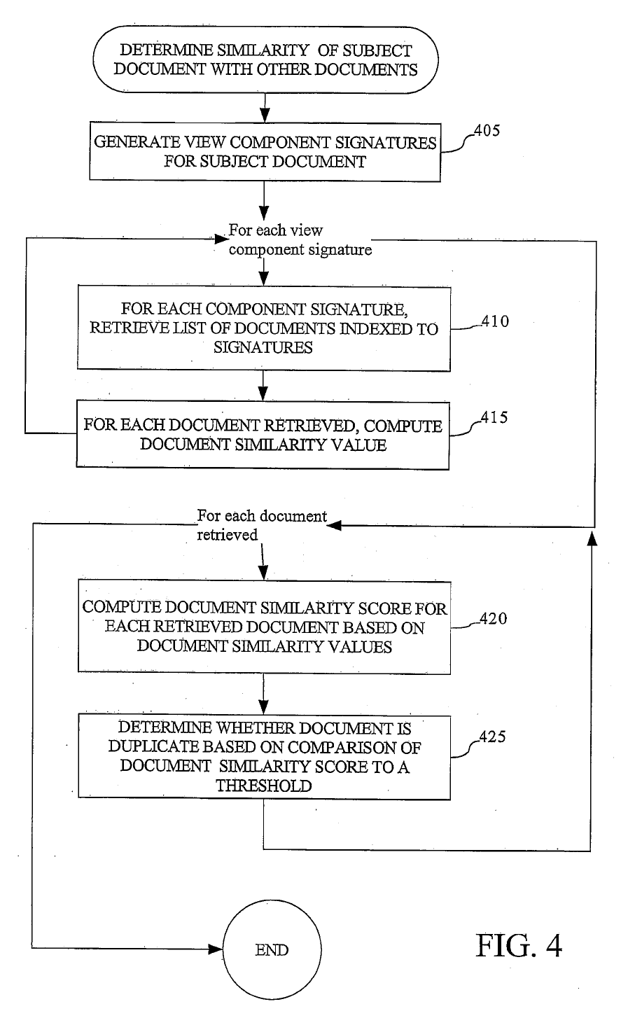

The view-based signatures of the documents, as described above, may be used in an embodiment to detect duplicate and near-duplicate documents. FIG. 4 is a flow diagram illustrating a procedure performed for checking whether a document is a full or partial duplicate of some other document by using view-based signatures stored in a signature store. according to an embodiment.

Referring to FIG. 4, at block 405, view component signatures are generated for a document view component of the subject document.

At block 410, for each signature generated for the document view component, the list of documents indexed to those signatures are retrieved.

At block 415, for each document retrieved, a view component similarity value is computed for each document in the list according the following formula:

(Number of common signatures)/(Number of combined unique signatures)

Combined unique signatures are the set of signatures that include the signatures for the view component stored in the index for the document in the list being compared to the subject document and the number of signatures generated for the subject document for the document view component. The number of common signatures is the number of signatures in the set shared by both the subject document and the document in the list.

For example, assume signatures S1 and S2 are generated for document D4. At block 410, the list of documents retrieved are D1, D2, and D3. The component similarity values computed for each document are as follows.

Similarity with D1=⅓ Since combined unique signatures are {S1, S2, S3}

Similarity with D2=1 Since combined unique signatures are {S1, S2}

Similarity with D3=⅓ Since combined unique signatures are {S1, S2, S3}

For each document retrieved, at block 420, a document similarity score is computed based on the document similarity values. According to an embodiment, document similarity score S is computed according to the following formula:

S=w₁*score₁(D,D1)+w₂*score₂(D,D1)+ . . . +wₙ*scoreₙ(D,D1)

Weight w₁ is a weight for the first view component; score₁ is the document similarity value for the first view component; w₂ is a weight for the second view component; score₂ is the document similarity value for the second view components, and so forth.

At block 425, it is determined whether a subject document and a retrieved document are to be deemed duplicates by comparing the similarity score of the retrieved document to a threshold value. If the similarity score is greater than (or equal to) a threshold value, the document is determined to be a duplicate.

In an embodiment, signatures are not used and a straight comparison or similarity calculation is made on the actual data comprising the application-specific view and/or application-specific view components. In another embodiment, the similarity scores may not be a numeric value compared with another numeric value. The similarity value may be a sliding scale or a component used by another approach to determining similarity.

### Implementing Mechanisms

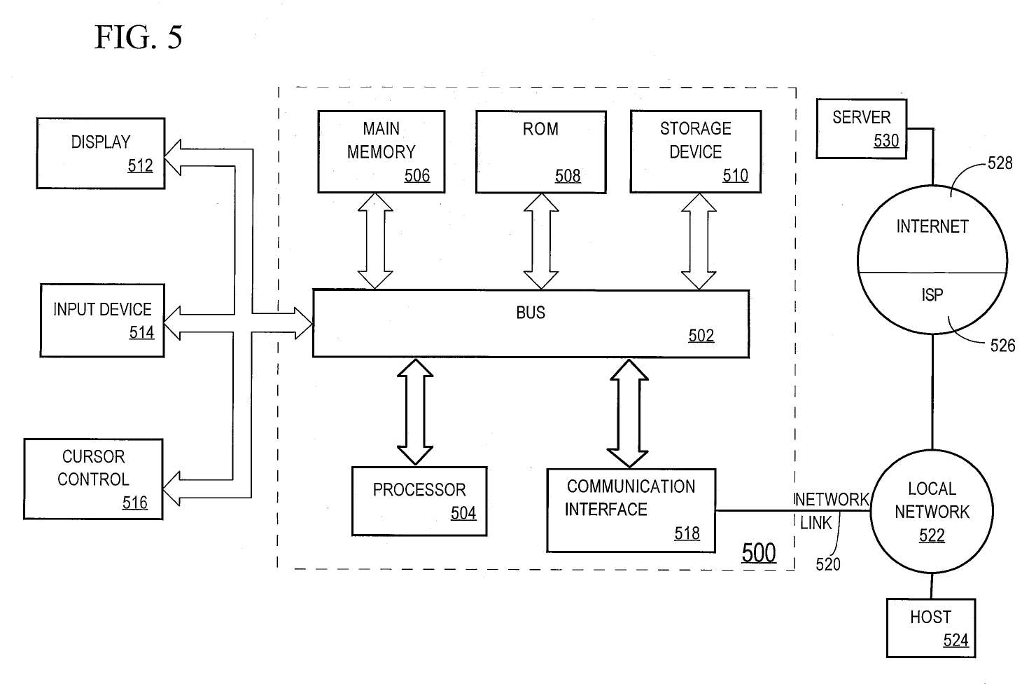

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 500, various machine-readable media are involved, for example, in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for detecting duplicate information, the computer-implemented method comprising:
extracting, from a certain document, first view data of a view, wherein the view includes a plurality of view components;
identifying within said first view data, a first view component datum for each of the plurality of view components;
generating, for the first view data, a first view signature that includes a plurality of first view component signatures;
wherein each first view component signature of said first view signature is generated based on a first view component datum of at least one view component of said plurality of view components;
making a determination of whether the first view data matches any other view data extracted from a plurality of other documents by comparing the plurality of first view signatures against other view signatures of said plurality of other documents; and
establishing the certain document as a duplicate based on the determination.

2. The method of claim 1, wherein making a determination of whether the first view data matches any other view data is based on determining similarity between each first view component datum of said first view data and a respective view component datum of another document.

3. The method of claim 2, wherein determining similarity between each first view component datum is based on comparing one or more first view component signatures generated for said each first view component datum to one or more view component signatures generated for said respective view component datum.

4. The method of claim 1,
wherein based on a certain view component of said plurality of view components:
second view component signatures are generated for a subset of documents of said other documents; and
a set of first view component signatures of said plurality of first view component signatures are generated;
wherein the method further includes:
for each document of said subset of documents, determining a similarity value based on:
a number of first view component signatures that match a second view component signature of said each document; and
a number of unique signatures among the set of first view component signatures and second view component signatures of said other document.

5. The method of claim 1, wherein the steps further include:
for a certain view component of said view, storing in an index other second view component signatures generated for said other documents for said certain view component, wherein an index key of said index comprises said second view component signatures;
wherein based on the certain view component, a set of first view component signatures of said plurality of first view component signatures is generated;
determining a subset of documents that said index indexes to said set of first view component signature;
for each document of said subset of documents, determining a similarity value based on:
a number of said set of first view component signatures that match a second view component signature of said each document; and
a number of unique signatures among said set of first view component signatures and second view component signatures of said other document.

6. The method of claim 1, wherein the steps further include:
for each view component of said plurality of view components, determining a similarity value between a respective first view component datum of said certain document and a respective view component datum of another document; and
establishing the certain document as a duplicate based on the similarity values generated for each view component of said plurality of view components.

7. The method of claim 6, wherein establishing the certain document as a duplicate based on the similarity values includes:
multiplying each similarity value by a weight to generate a product; and
establishing the certain document as a duplicate based on a sum of the products generated for each of the similarity values.

8. The method of claim 1, wherein each first view component signature of said plurality of view components is a hash value.

9. A computer-implemented method for detecting duplicate information, the computer-implemented method comprising:
extracting, from a certain document, first view data of a view, wherein the view includes a plurality of view components;
identifying within said first view data, a first view component datum for each of the plurality of view components;
generating a plurality of first view component signatures, wherein each first view component signature of said plurality of first view signatures is generated based on a first view component datum of at least one view component of said plurality of view components;
making a determination of whether the first view data matches any other view data extracted from a plurality of other documents;
wherein making a determination includes:
for each view component of said plurality of view components, generating a similarity value reflecting similarity between a respective first view component datum of said certain document and a respective view component datum of another document, wherein generating a similarity value is based on a respective first view component signature of said plurality of first view component signatures; and
establishing the certain document as a duplicate based on the similarity values generated for each view component of said plurality of view components.

10. The method of claim 9, wherein generating a similarity value is based on:
a number of first view component signatures generated for said respective first view component datum that match a second view component signature of said another document; and
a number of unique signatures among the first view component signatures generated for said respective first view component datum and second view component signatures of said another document.
